(19) United States
(12) Patent Application Publication
(10) Pub. No.: US 2024/0227797 A9
(43) Pub. Date: Jul. 11, 2024

(54) METHOD AND DEVICE FOR OPERATING A LONGITUDINAL GUIDANCE OF A MOTOR VEHICLE

(71) Applicant: Robert Bosch GmbH, Stuttgart (DE)

(72) Inventor: Yixuan Voigt, Stuttgart (DE)

(21) Appl. No.: 18/479,178

(22) Filed: Oct. 2, 2023

(30) Foreign Application Priority Data
Oct. 24, 2022 (DE) 10 2022 211 251.2

(51) Int. Cl. B60W 30/14; B60W 30/095; B60W 60/00

(52) U.S. Cl. CPC B60W 30/143; B60W 30/0956; B60W 60/0011; B60W 60/0015; B60W 2554/4041; B60W 2554/4046

(57) ABSTRACT

A method for operating a driving assistant for longitudinal guidance of a motor vehicle. The method includes: performing automated longitudinal guidance of the motor vehicle in a first lane at a relative maximum speed; evaluating a traffic situation in an adjacent lane of the motor vehicle; making a decision regarding an increase in the relative maximum speed taking into account an identified risk situation for the motor vehicle due to the traffic situation in the adjacent lane. A device configured to carry out the method, and a corresponding computer program, are also described.

### CROSS REFERENCE

The present application claims the benefit under 35 U.S.C. § 119 of German Patent Application No. DE 10 2022 211 251.2 filed on Oct. 24, 2022, which is expressly incorporated herein by reference in its entirety.

### BRIEF SUMMARY

The present invention relates to a method for operating a driving assistant for longitudinal guidance of a motor vehicle including the method steps of performing automated longitudinal guidance of the motor vehicle in a first lane at a relative maximum speed; evaluating a traffic situation in an adjacent lane of the motor vehicle; making a decision regarding an increase in the relative maximum speed taking into account an identified risk situation for the motor vehicle due to the traffic situation in the adjacent lane. Furthermore, the present invention relates to a device configured to carry out the method, and a corresponding computer program.

### BACKGROUND INFORMATION

Automated longitudinal control, also known as adaptive cruise control (ACC), is described in the related art. In an ACC, the speed of the motor vehicle is adapted to a maximum speed, for example. The maximum speed is reduced, for example, when a slower road user is driving in the lane ahead of the vehicle and a safety distance is undershot. In this case, transverse control is assumed by the driver.

Furthermore, construction zone assistants are described in the related art. The Bosch construction zone assistant is, for example, an extension of a lane keeping assistant and assists the driver in the case of close lane guidance in order to maintain a lateral safety distance from vehicles in the adjacent lane and guard rails. In addition, the video sensor measures the free area in front of the vehicle. As a result, the construction zone assistant can warn the driver of a narrow point in a highway construction zone in good time if the vehicle is too wide for the narrowed lane.

German Patent Application No. DE 10 2005 023 185 A1, for example, describes a lane change assistant for motor vehicles with a monitoring means for monitoring the traffic in front of and behind the host vehicle and a decision means for deciding whether a safe lane change is possible.

Furthermore, European Patent No. EP 3 044 061 B1 relates to a method for controlling a host vehicle, wherein a control unit is configured to reduce the previously determined safety distance to a second minimum safety distance when a critical rear collision condition is detected, and to automatically increase the speed of the host vehicle to maintain the second minimum safety distance between the host vehicle and the vehicle driving ahead of the host vehicle when a critical rear collision condition is detected.

European Patent No. EP 1 359 047 B1, for example, relates to an automatic vehicle speed control device, wherein “driving in the fleet” is made possible, wherein the host vehicle travels at the same speed as that of the preceding vehicle by increasing the upper limit of the vehicle speed existing in the host vehicle's distance control, wherein the upper limit of the vehicle speed is increased above the previously set speed while controlling the vehicle distance.

### SUMMARY

A method according to the present invention advantageously allows for safe (partially) automated guidance of a motor vehicle, in particular on multi-lane roads. In particular, the risk of an accident is reduced here. In addition, the described function gives the driver an increased feeling of safety and the feeling that his/her (semi-)autonomously driving vehicle is “thinking along” with him/her. This results in increased acceptance by the user. This in turn leads to more frequent use and thus to an increase in driver relief and a reduction in the probability of accidents.

According to the present invention, this is made possible by features disclosed herein. Example embodiments of the present invention are disclosed herein.

The method according to an example embodiment of the present invention for operating a driving assistant for longitudinal guidance of a motor vehicle is characterized by the method steps of performing automated longitudinal guidance of the motor vehicle in a first lane at a relative maximum speed; evaluating a traffic situation in an adjacent lane of the motor vehicle; making a decision regarding an increase in the relative maximum speed taking into account an identified risk situation for the motor vehicle due to the traffic situation in the adjacent lane.

The term “traffic situation” is intended to describe a traffic situation existing at the current time. A traffic situation can be formed by one or more road users. For example, the traffic situation comprises a driving trajectory or a driving profile and/or the driving behavior of a single other vehicle. An “adjacent lane” is to be understood in particular as a neighboring lane, i.e., a further lane directly adjoining the first lane to the left or right. The term “risk situation” is to be understood as a situation in which there is a certain risk of the motor vehicle (also called an ego motor vehicle) in the first lane. In particular, this is to be understood as a situation that involves a certain probability of an accident. In this case, a risk level of the risk situation can also be taken into account, which is measured or defined, for example, as the time period until a possible collision (time-to-collision). In such a situation, an increase in the currently executed relative maximum speed or the currently driven speed can be decided. An increase can take place, for example, within a defined range, wherein this can be defined as a percentage or an absolute excess of the current speed. Alternatively or additionally, the increase can also be defined as an acceleration value, for example as a limited or maximum possible acceleration of the motor vehicle, as long as the risk situation exists.

Against this background, the method can be designed, for example, in such a way that the driving behavior of a further vehicle in a lane adjacent to the motor vehicle is determined and evaluated and an accident probability for the ego motor vehicle is determined on the basis of the driving behavior of the further vehicle. Subsequently, taking into account the overall situation, a decision is made regarding an increase in the defined maximum speed and, if necessary, a limited execution of the increase takes place as long as the determined accident probability exists.

In an advantageous embodiment of the present invention, in the method, the relative maximum speed is a maximum speed defined by the driver, wherein this maximum speed can be limited by further restrictions.

The term “relative maximum speed” is understood to mean the regular speed at which the motor vehicle is moved by means of automated longitudinal guidance at the time of detection of the risk situation. This speed substantially corresponds to a speed limit defined by the driver. However, a speed that is specified by the driver as a maximum speed is often not set by the driving assistant due to further restrictions. For example, regulatory speed limits for the current road section (especially speed limit signs) can be determined and taken into account by the driving assistant. Alternatively or additionally, the speed can also be limited due to the current traffic situations (e.g. road users driving ahead more slowly). Automated limitation of the speed by the driving assistant due to the driving situation (e.g. weather conditions, rain, snow, black ice) is also conceivable. The (semi-)automated longitudinal guidance thus comprises speed control.

According to an example embodiment of the present invention, the present invention can thus advantageously provide an increase in the current first speed of the motor vehicle (relative maximum speed) to a higher speed. This increase can be carried out, for example, with the maximum possible acceleration of the motor vehicle. As soon as the risk situation for the motor vehicle has been resolved, for example a possible collision area has been left, the reached second speed can be reduced again to the first speed (relative maximum speed), for example.

In one possible embodiment of the present invention, the method is characterized in that a road user is evaluated in the adjacent lane, which road user drives substantially alongside the motor vehicle.

This means that when evaluating the traffic situation in the adjacent lane of the ego motor vehicle, it is checked whether a risk situation for the ego motor vehicle results from another vehicle that is traveling in the adjacent lane alongside the ego motor vehicle.

In a preferred embodiment of the present invention, in the method, a driving profile and/or a driving behavior of a road user in the adjacent lane is evaluated.

This means that when evaluating the traffic situation in the adjacent lane of the ego motor vehicle, it is checked whether a risk situation for the ego motor vehicle results from the driving profile and/or the driving trajectory and/or the driving behavior of another vehicle in the adjacent lane.

In an alternative development of the present invention, in the method, the decision regarding the increase in the relative maximum speed takes into account whether an alternative driving maneuver can resolve the risk situation.

This means that the situation is evaluated to determine whether an increase in speed is a suitable possibility for reducing the risk. The speed increase is in particular a suitable option when no alternative possibilities are available or also entail significant disadvantages, for example an increase in the risk situation or only a shift in the risk from a first risk situation to another second risk situation. Against this background, the method can also advantageously comprise the following method steps: determining and evaluating whether alternative driving maneuvers of the motor vehicle could also eliminate or significantly reduce an accident risk.

In one possible embodiment of the present invention, in the method, a braking maneuver is evaluated as an alternative driving maneuver that can resolve the risk situation.

This means that a positive decision to increase the relative maximum speed is advantageously achieved only if, for example, a braking maneuver of the ego motor vehicle is not possible or at least does not create a condition in which an accident risk with respect to the ego motor vehicle is reduced or at least considerably reduced. A braking maneuver is not possible, for example, if a further vehicle is traveling a short distance behind the ego motor vehicle in the same lane. A braking maneuver is also inappropriate, for example, if it increases the risk situation with respect to the ego motor vehicle. Against this background, the method comprises, for example, the method steps of determining and evaluating a traffic situation in the ego vehicle's own lane behind the motor vehicle. In this case, it is also conceivable for the driver to have a setting option to change, for example, the sensitivity of the increase in speed. It is thus conceivable for the driver to use settings to influence the triggering thresholds, for example the distance and/or acceleration differences between the ego vehicle and the subsequent vehicle.

In a preferred embodiment of the present invention, in the method, a lane change maneuver is evaluated as an alternative driving maneuver that can resolve the risk situation.

This means that a positive decision to increase the relative maximum speed is advantageously achieved only if, for example, changing to another lane is not possible. A “lane change” or “lane change maneuver” means a change of the motor vehicle from the current lane to another lane, in particular to a lane that is remote from the lane from which the risk situation originates. For example, changing to the left of three lanes when the ego motor vehicle is traveling in the center lane and the risk originates from a vehicle in the right lane, or, for example, changing to the right lane, when the risk originates from a vehicle in the left lane.

A lane change is not possible if, for example, a lane change maneuver is not structurally feasible, for example because there is no other lane. Situations are also possible in which a lane change is prohibited in accordance with regulations, for example as indicated by a solid line. Depending on the embodiment of the present invention (or also the settings made by the driver), such a possible but unauthorized lane change can be evaluated as a possible or not possible option.

According to an example embodiment of the present invention, a lane change is also not possible if a lane change maneuver is not situationally feasible. This is the case, for example, when another lane is present, but a change is currently not possible, for example because a sufficient gap in traffic (in the other lane) cannot be detected.

According to an example embodiment of the present invention, it is also possible for a driver setting to be made with respect to the stringency of these criteria. With a changed setting, correspondingly more frequent or fewer speed increases would be carried out, and instead, evasive maneuvers to the left would be proposed or executed in an automated manner even in the case of small traffic gaps.

Against this background, the method may also advantageously comprise the method steps of determining and evaluating a traffic situation in a second adjacent lane of the motor vehicle that is remote from the adjacent lane of the motor vehicle that generates the risk situation.

In an alternative embodiment, in the method, the decision regarding the increase in the relative maximum speed takes into account whether an increase in the relative maximum speed can be executed.

This means that the overall situation is evaluated to determine whether an increase in speed can also be implemented practically and is thus an actual solution option. For this purpose, it is checked whether an increase in the relative maximum speed is actually possible in the current situation in a manner such that an accident risk with respect to the motor vehicle is eliminated or reduced. Against this background, the method also advantageously comprises the method steps of determining and evaluating a practical feasibility of an increase in the relative maximum speed.

In an advantageous further development of the present invention, in the method, a traffic situation of the motor vehicle is evaluated in order to check the feasibility of the increase in the relative maximum speed.

This means that the overall situation is evaluated to determine whether a further vehicle is located in the lane in front of the ego motor vehicle or whether the lane is free and thus a speed increase of the ego motor vehicle can also be implemented practically. If a further vehicle is detected in the lane ahead of the ego motor vehicle, it is evaluated whether the current distance between the ego motor vehicle and the further vehicle is sufficient to execute an increase in the relative maximum speed in order to resolve the risk situation. A defined safety distance should still be maintained here. This safety distance can be defined, for example, as a function of the current and/or estimated target speed of the ego motor vehicle. If it is recognized that the distance between the vehicles is not sufficient to continue to maintain the defined safety distance during a possible speed increase, it is evaluated in a next step whether a reduction in the defined safety distance seems possible. Thus, a safety distance can be reduced within defined limits under certain conditions, for example in the case of a dry road and a high level of validity in the detection of other driving objects and driving trajectories. Against this background, the method also advantageously comprises the method steps of determining and evaluating a traffic situation in the ego vehicle's own lane in front of the motor vehicle.

In one possible embodiment of the present invention, in the method, a driving situation of the motor vehicle is evaluated in order to check the feasibility of the increase in the relative maximum speed.

This means that the overall situation is evaluated to determine whether a speed increase of the ego motor vehicle can also be practically implemented on the basis of ambient conditions. In this case, in particular the current and imminent course of the road is taken into account; for example, it is checked that no sharp curve is imminent, which would lead to an increased risk if the speed is increased. The determination can take place by evaluating video data and/or a digital road map. Furthermore, a check of weather conditions can also be advantageous. Thus, it is possible to determine, for example, whether it is raining or snowing. It also advantageously possible to estimate whether the road is icy. Against this background, the method also advantageously comprises the method steps of determining and evaluating a driving situation of the motor vehicle.

In a preferred embodiment of the present invention, in the method, a performance of the motor vehicle is evaluated in order to check the feasibility of the increase in the relative maximum speed.

This means that the overall situation is evaluated to determine whether the performance of the motor vehicle is sufficient to resolve the existing risk situation. Technical parameters of the ego motor vehicle such as, for example, maximum speed or acceleration capacity (also elasticity) can be taken into account. This absolute performance can be combined together with the currently retrieved power level and the existing environmental situation (e.g., the gradient of the road). The evaluation advantageously also accordingly takes into account the risk level of the risk situation. Against this background, the method also advantageously comprises the method step of determining and evaluating a performance of the motor vehicle.

In an alternative embodiment of the present invention, in the method, the decision regarding an increase in the relative maximum speed takes into account the overall situation with respect to the motor vehicle, in particular, it takes into account whether an increase in the maximum speed is possible for the motor vehicle in the current driving situation and whether an increase appears to be appropriate taking into account alternative driving maneuvers for resolving the risk situation.

In an advantageous further development of the present invention, the method includes the steps of executing an increase in the relative maximum speed to resolve the risk situation, adapting a speed of the motor vehicle after the resolution of the risk situation, continuing the automated longitudinal guidance of the motor vehicle in the first lane.

This means that the speed is increased for a limited time. As soon as it is determined that the risk situation no longer exists, the excessive speed of the ego vehicle is reduced. The current speed is reduced to a new relative maximum speed. Subsequently, the (semi-)automated longitudinal guidance of the ego motor vehicle is performed at the set new relative maximum speed. This new relative maximum speed can, for example (under unchanged ambient conditions), be the same speed as the first relative maximum speed at which the ego motor vehicle was traveling before the risk situation was detected.

In one possible embodiment of the present invention, in the method, a motor vehicle driver is informed that an increase in the relative maximum speed is to be executed.

This means that technical preparations are made in order to inform the driver about the imminent speed increase. For this purpose, data signals are encoded and provided accordingly. The data signals can be used to control output devices that provide the driver with corresponding information. The information can be communicated to the driver visually, for example by means of a display, or for example acoustically by means of voice output. Of course, haptic information such as seat vibration is also conceivable. In addition to information prior to the actual execution, the information can also be provided alternatively or additionally during the execution in order to explain the deviation from the set speed to the driver.

In a preferred embodiment of the present invention, in the method, there is a possibility of influencing the execution of an increase in the relative maximum speed by the vehicle driver. Advantageously, due to the timely information regarding the planned driving maneuver, the driver can prevent an automated execution if he wishes. The prevention of automated execution can consist of canceling the planned increase or overriding the automated driving maneuver by the driver, for example by stronger acceleration or by braking.

This method can be implemented, for example, in software or hardware or in a mixed form of software and hardware, for example in a control device.

The approach presented here further provides a device which is designed to carry out, control or implement the steps of a variant of a method presented here in corresponding apparatuses. The object of the present invention can also be achieved quickly and efficiently by this design variant of the present invention in the form of a device.

In the present case, a device can be understood to be an electrical device that processes sensor signals and, on the basis of these signals, outputs control and/or data signals. The device can have an interface that can be designed as hardware and/or software. In a hardware embodiment, the interfaces can be part of a so-called system ASIC, which comprises a variety of functions of the device. However, it is also possible for the interfaces to be separate integrated circuits or at least partially consist of discrete components. In the event of a software embodiment being used, the interfaces can be software modules that are present, for example, on a microcontroller in addition to other software modules.

The device can therefore include an assistance system for (semi-) automated control of the longitudinal guidance, as well as an assistance system for detecting a risk situation for a motor vehicle, or an assistance system for assisting the driver by transmitting information for vehicle guidance. Furthermore, a device can be considered to be an environment detection device, in particular a camera or other optical recording device and/or a central or decentralized control device configured to control one of the aforementioned devices or to carry out the described method.

A computer program product or a computer program with program code that can be stored on a machine-readable carrier or storage medium, such as a semiconductor memory, a hard disk memory, or an optical memory, and that is used for carrying out, implementing, and/or actuating the steps of the method according to one of the embodiments of the present invention described above is advantageous as well, in particular when the program product or program is executed on a computer or a device.

It should be noted that the features listed individually in the description may be combined with one another in any technically useful manner and indicate further embodiments of the present invention. Further features and usefulness of the present invention will be apparent from the description of exemplary embodiments with reference to the accompanying figures.

### BRIEF DESCRIPTION OF THE DRAWINGS

FIGS. 1-3 show schematic representations of example embodiments of the present invention in various environmental and traffic situations.

FIG. 4 is a representation of the method steps of an example embodiment of the present invention.

### DETAILED DESCRIPTION OF EXAMPLE EMBODIMENTS

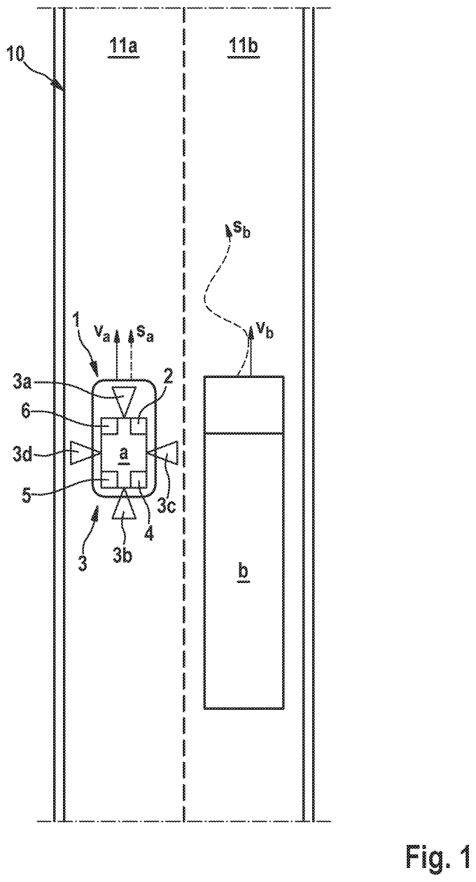

FIG. 1 is a schematic representation of an embodiment of the invention in a first environmental and traffic situation.

A motor vehicle 1 (also referred to as ego vehicle a) is shown on a roadway 10. The roadway 10 comprises two lanes, a left lane 11a (also referred to as first lane) and a right lane 11b (also referred to as second lane or adjacent lane).

The motor vehicle 1 comprises a driving assistance system 2 (also referred to as a driving assistant) for automated longitudinal guidance (for example ACC). Also shown is a sensor system 3 for detecting the surroundings. Said sensor system comprises a sensor 3a for detecting the front surroundings (for example a front camera), a sensor 3b for detecting the rear surroundings (for example a rear camera), and a plurality of sensors 3c for detecting the side surroundings (for example side cameras). Of course, radar, lidar, or other suitable sensor types can also be used alternatively or additionally. The motor vehicle 1 further comprises a computing unit 4 (also referred to as a control unit) for evaluating the sensor data and/or for carrying out the method and/or for controlling the actuators. The motor vehicle 1 further comprises an actuator system 5. Said actuator system comprises, for example, an actuator for longitudinal control. Furthermore, a device 6 is configured for informing the driver. Said device can transmit information to the driver, for example, in a visual and/or acoustic and/or haptic manner.

In the representation, the motor vehicle 1 moves along the travel trajectory s a at the speed Vₐ. This speed corresponds to the desired maximum speed set by the driver. In the traffic situation shown, a further vehicle b is located in the right lane 11b, in this case a truck. The vehicle 1 is located next to the front part of the truck, alongside the driver's cab. The vehicle b travels at the speed V_{b}, which is slightly lower than the speed Vₐ. Furthermore, the driving trajectory s b thereof is shown. Said driving trajectory is serpentine. At the very least, a low level of attention can be inferred from this driving behavior. The driving profile, also in combination with the size of the vehicle b, also limits the remaining driving width of the motor vehicle 1. Overall, a certain probability can be determined for a possible accident. Therefore, at least a risk situation that is triggered by the traffic situation in the adjacent lane 11b can be detected.

In order to resolve this acute risk situation, the motor vehicle 1 accelerates and thus increases the relative maximum speed. In this situation, corresponding information is communicated to the vehicle driver by means of the device 6. The acceleration or increase in the relative maximum speed is continued until the risk situation is resolved. For example, the increase takes place until the motor vehicle 1 has left the possible collision region with the vehicle b. After the risk situation has been resolved, the speed reached is reduced in an automated manner, for example to the previously executed relative maximum speed.

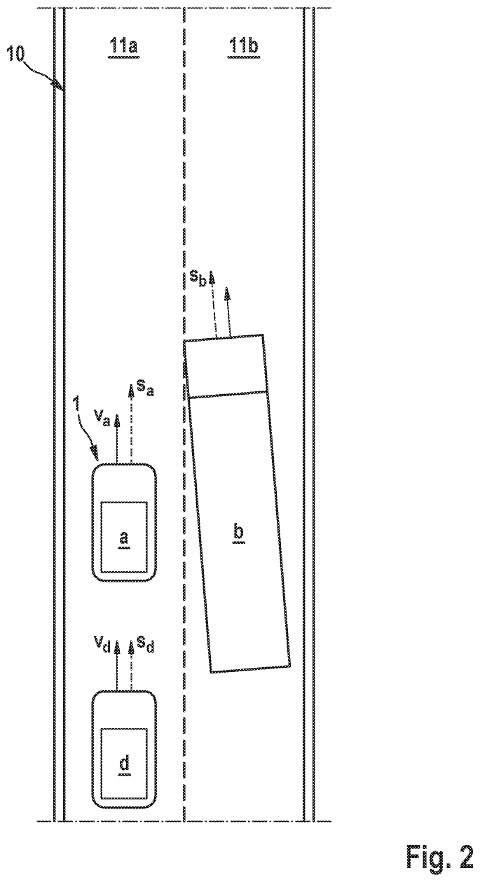

FIG. 2 is a schematic representation of an embodiment of the invention in a second environmental and traffic situation.

The motor vehicle 1 again drives at the relative maximum speed Vₐ in the first lane 11a. In this case, the driving trajectory s_{b} of the vehicle b in the second lane 11b has a straight driving profile. However, the direction of travel of the driving trajectory s_{b} indicates that a lane crossing from the second lane 11b into the first lane 11a may be imminent. The motor vehicle 1 is located substantially alongside vehicle b. Therefore, there is again a risk situation for the motor vehicle 1.

In contrast to the previous situation, the motor vehicle 1 is traveling somewhat further back, to be precise, alongside the trailer of the truck (vehicle d). Nevertheless, a braking maneuver of the motor vehicle 1 is not suitable to resolve the risk situation. In the traffic situation shown, a further vehicle d is located in the left lane 11a directly behind the motor vehicle 1. The vehicle d travels at the speed V_{d}, which is slightly higher than the speed Vₐ. Furthermore, the driving trajectory s d of the vehicle d is shown, so that a further reduction in the distance is to be expected. Emergency braking of the motor vehicle 1 could possibly resolve the risk situation with respect to the vehicle d, but would trigger a new risk situation with respect to a rear-end accident by the vehicle d.

Therefore, a decision is also made in this situation to increase the relative maximum speed to resolve the risk situation.

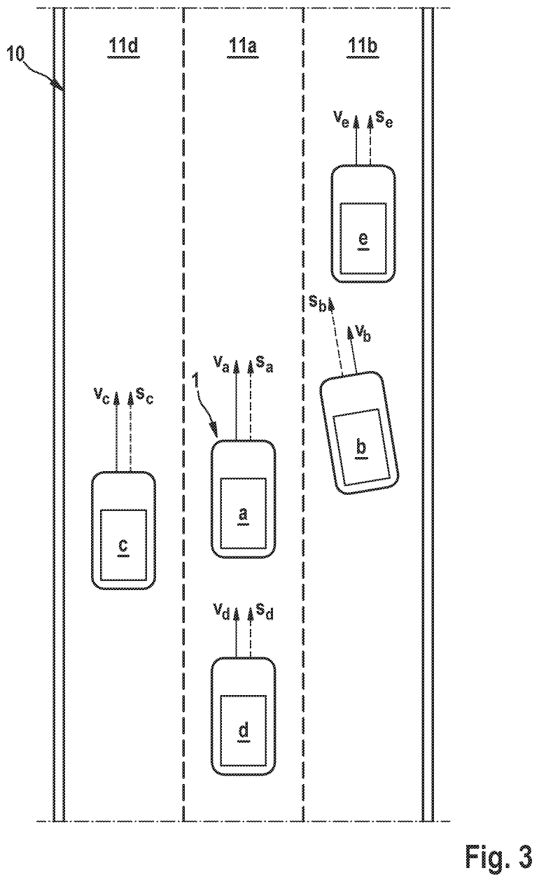

FIG. 3 is a schematic representation of an embodiment of the invention in a third environmental and traffic situation.

The motor vehicle 1 again drives at the relative maximum speed Vₐ in the first lane 11a. In this case, the driving trajectory s_{b} of the vehicle b in the second lane 11b again has a straight driving profile and indicates that a lane crossing from the second lane 11b to the first lane 11a may be imminent. The motor vehicle 1 is located substantially alongside vehicle b.

Therefore, there is again a risk situation for the motor vehicle 1.

A braking maneuver of the motor vehicle 1 is again not suitable to resolve the risk situation because of a following vehicle d.

In contrast to the previous situation representations, this time a third lane 11c is located to the left of the first lane 11a in which the motor vehicle is located. Nevertheless, a lane change maneuver of the motor vehicle 1 is not suitable to resolve the risk situation. In the traffic situation shown, a further vehicle c is located in the third lane 11c, just behind the motor vehicle 1. The vehicle c travels at the speed V_{c}, which is similar to the speed Vₐ. Furthermore, the driving trajectory sc of the vehicle c is shown, so that a change in the driving situation is not to be expected in the short term.

Therefore, a decision is also made in this situation to increase the relative maximum speed to resolve the risk situation.

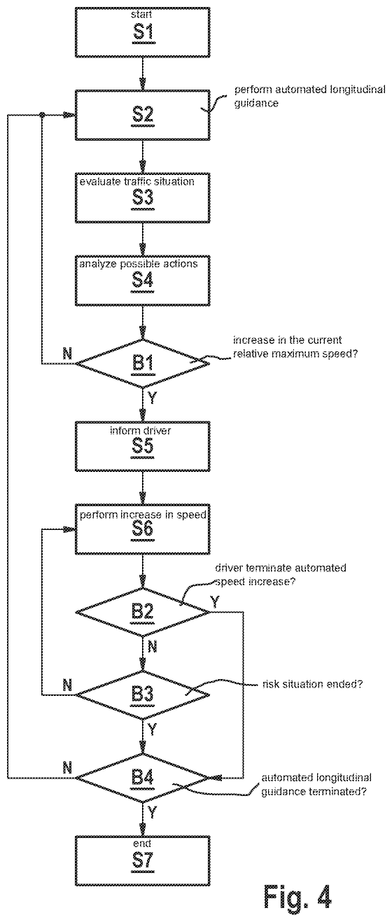

FIG. 4 is a representation of the method steps of an embodiment of the invention. In a first step S1, the method is started. In a step S2, the automated longitudinal guidance of the motor vehicle 1 in the first lane is performed. For example, the automated longitudinal guidance is activated by the driver of the motor vehicle. The automated longitudinal guidance regulates the speed of the motor vehicle according to the traffic situation to a relative maximum speed set by the driver. Alternatively or additionally, a maximum speed permitted for the relevant road section can also limit the relative maximum speed. In a step S3, the traffic situation is evaluated in a first adjacent lane of the motor vehicle to determine a risk situation in relation to the motor vehicle in the first lane. In a next step S4, possible actions for the motor vehicle are analyzed. In particular, specific environmental aspects are determined and it is evaluated whether a defined alternative driving maneuver is possible. For example, in this case the traffic situation is determined and evaluated in the same lane behind and/or in front of the motor vehicle. Alternatively or additionally, the traffic situation can also be determined and evaluated in a further adjacent lane of the motor vehicle. In this case, step S4 can be carried out continuously. Alternatively, this step is carried out only when a risk situation has been determined. In a subsequent condition B1, a decision is made about an increase in the current relative maximum speed. If a decision is made to perform an increase (Y branch), a driver is informed in a next step S5. This information can be acoustic and/or visual and/or haptic. In a further step S6, the increase in the speed is performed. It should be noted here that steps S5 and S6 can of course be carried out in parallel. The driver still has the ability to terminate or override the automated speed increase by intervening in the system, as shown in the condition B2. However, if the driver does not terminate the automated speed increase (N branch), the increase is performed as long as the risk situation exists. This is monitored with a condition B3. The risk situation can then be determined to have ended (Y branch) if, for example, it is detected that the driving behavior of the road user in the adjacent lane has changed or, for example, the motor vehicle could leave a possible collision region in the first lane. In such a case, a condition B4 checks whether the automatic longitudinal guidance has been terminated.

If this is not the case (N branch), the automatic longitudinal guidance is continued with step S2. If this is the case (Y branch), the method ends in step S7.

What is claimed is:

1. A method for operating a driving assistant for longitudinal guidance of a motor vehicle, comprising the following steps:
performing automated longitudinal guidance of the motor vehicle in a first lane at a relative maximum speed;
evaluating a traffic situation in an adjacent lane of the motor vehicle; and
making a decision regarding an increase in the relative maximum speed taking into account an identified risk situation for the motor vehicle due to the traffic situation in the adjacent lane.

2. The method according to claim 1, wherein the evaluating includes evaluating a road user in the adjacent lane, the road user driving substantially alongside the motor vehicle.

3. The method according to claim 1, wherein the evaluating includes evaluating a driving profile and/or a driving behavior of a road user in the adjacent lane.

4. The method according to claim 1, wherein the decision regarding the increase in the relative maximum speed takes into account whether an alternative driving maneuver can resolve the risk situation.

5. The method according to claim 4, wherein a braking maneuver is evaluated as the alternative driving maneuver that can resolve the risk situation.

6. The method according to claim 4, wherein a lane change maneuver is evaluated as the alternative driving maneuver that can resolve the risk situation.

7. The method according to claim 1, wherein the decision regarding the increase in the relative maximum speed takes into account whether an increase in the relative maximum speed can be carried out.

8. The method according to claim 7, wherein a traffic situation of the motor vehicle is evaluated in order to check feasibility of the increase in the relative maximum speed.

9. The method according to claim 8, wherein a driving situation of the motor vehicle is evaluated in order to check the feasibility of the increase in the relative maximum speed.

10. The method according to claim 1, further comprising:
executing the increase in the relative maximum speed to resolve the risk situation;
adapting a speed of the motor vehicle after the resolution of the risk situation;
continuing the automated longitudinal guidance of the motor vehicle in the first lane.

11. A device configured to operate a driving assistant for longitudinal guidance of a motor vehicle, the device configured to:
perform automated longitudinal guidance of the motor vehicle in a first lane at a relative maximum speed;
evaluate a traffic situation in an adjacent lane of the motor vehicle; and
make a decision regarding an increase in the relative maximum speed taking into account an identified risk situation for the motor vehicle due to the traffic situation in the adjacent lane.

12. A non-transitory machine-readable storage medium on which is stored a computer program for operating a driving assistant for longitudinal guidance of a motor vehicle, the computer program, when executed by a computer, causing the computer to perform the following steps:
performing automated longitudinal guidance of the motor vehicle in a first lane at a relative maximum speed;
evaluating a traffic situation in an adjacent lane of the motor vehicle; and
making a decision regarding an increase in the relative maximum speed taking into account an identified risk situation for the motor vehicle due to the traffic situation in the adjacent lane.
